(19) United States
(12) Patent Application Publication
(10) Pub. No.: US 2018/0273805 A1
(43) Pub. Date: Sep. 27, 2018

(54) ROLL TO ROLL METHODS FOR MANUFACTURING DRY ADHESIVE PRODUCTS

(71) Applicants: Shine-Chung WONG, Akron, OH (US); Barry ROSENBAUM, Shaker Heights, OH (US); Fei WANG, Akron, OH (US)

(72) Inventors: Shing-Chung Wong, Akron, OH (US); Barry Rosenbaum, Shaker Heights, OH (US); Fei Wang, Akron, OH (US)

(21) Appl. No.: 15/762,338

(22) PCT Filed: Sep. 23, 2016
(86) PCT No.: PCT/US16/53379

§ 371 Date: Mar. 22, 2018

Related U.S. Application Data
(60) Provisional application No. 62/222,347, filed on Sep. 23, 2015.

(51) Int. Cl. C09J 7/20; D04H 1/728; C09J 9/00

(52) U.S. Cl. CPC C09J 7/20; C09J 9/00; D04H 1/728

(57) ABSTRACT

Embodiments of the present invention relate to continuous, roll-to-roll methods of manufacturing dry adhesive products. A method for producing a dry adhesive product includes providing a fiber-forming composition to a fiber-forming means; passing a backing material having a first surface and a second surface along a first roller to thereby advance the backing material to the fiber-forming means; allowing the fiber-forming means to form a dry adhesive layer made from the fiber-forming composition on the first surface of the backing material; and passing the backing material having the dry adhesive layer thereon along a second roller.

### CROSS-REFERENCE TO RELATED APPLICATIONS

The present application claims priority to U.S. Provisional Patent Application No. 62/222,347, filed Sep. 23, 2015, incorporated herein by reference.

### FIELD OF THE INVENTION

Embodiments of the present invention relate to continuous, roll-to-roll methods of manufacturing dry adhesive products. Embodiments of the present invention relate to dry adhesive products. Embodiments of the present invention relate to dry adhesives made from a fiber-forming composition. Embodiments of the present invention relate to dry adhesives made from electrospun nanofibers.

### BACKGROUND OF THE INVENTION

An adhesive is a kind of material that can bond items together. Most adhesives are liquid or semi-liquid materials, with three major categories including: physically hardening adhesives, chemically curing adhesives and pressure sensitive adhesives. However, these liquid or semi-liquid materials suffer from many disadvantages. For example, many include VOC's or other harmful solvents. Also, certain of these materials become permanently adhered upon drying.

Recent efforts have focused on adhesives that are made as dry adhesives. These dry adhesives have included vertically aligned carbon nanotubes and vertically aligned fibrils, such that the tips of the vertically aligned materials mimic the adhesive characteristics of the seta of a gecko. But, these dry adhesives having vertically aligned materials are made using processes that are expensive, intricate, and non-continuous. Particularly, it is difficult to secure the vertically aligned materials to a backing material that carries the vertically aligned materials. Exemplary methods of making dry adhesives having vertically aligned materials include vapor deposition and direct laser writing on to the backing material.

In semi-related technology, others have utilized electrospinning techniques to produce products involving electrospun fibers. One example of this is the use of electrospinning to produce high performance air filters. However, these known electrospinning processes do not use roll-to-roll methods to continuously produce electrospun dry adhesive products. Thus, there remains a need in the art for improved methods of manufacturing dry adhesives, particularly electrospun dry adhesives

### SUMMARY OF THE INVENTION

A first embodiment provides a method for producing a dry adhesive product comprising the steps of providing a fiber-forming composition to a fiber-forming means; passing a backing material having a first surface and a second surface along a first roller to thereby advance the backing material to the fiber-forming means; allowing the fiber-forming means to form a dry adhesive layer made from the fiber-forming composition on the first surface of the backing material; and passing the backing material having the dry adhesive layer thereon along a second roller.

A second embodiment provides a method as in the first embodiment, wherein the fiber-forming means is an electrospinning apparatus, such that said step of allowing is a step of electrospinning.

A third embodiment provides a method as in the either the first or second embodiment, wherein said steps of passing a backing material along a first roller, allowing the fiber-forming means to form a dry adhesive layer, and passing the backing material having the dry adhesive layer thereon along a second roller are performed continuously.

A fourth embodiment provides a method as in any of the first through third embodiments, wherein all steps are performed continuously.

A fifth embodiment provides a method as in any of the first through fourth embodiments, further comprising a step of applying an additional layer to the second surface of the backing material before the backing material is advanced to the fiber-forming means and wherein the first roller is positioned downstream from the fiber-forming means.

A sixth embodiment provides a method as in any of the first through fifth embodiments, where the backing material is selected from the group consisting of metals, textiles, cellulosic materials, polymer films, plastic films, and foams, and where the additional layer is selected from the group consisting of metals, textiles, cellulosic materials, polymer films, plastic films, pressure sensitive adhesives, and foams.

A seventh embodiment provides a method as in any of the first through sixth embodiments, wherein the dry adhesive layer has a peel strength of 1 psi or less, measured at an angle of separation of 180 degrees, and a shear adhesion of 25 psi or more.

An eighth embodiment provides a method as in any of the first through seventh embodiments, further comprising the step of applying a release liner to the dry adhesive layer to form a multi-layered product.

A ninth embodiment provides a method as in any of the first through eighth embodiments, further comprising the step of collecting the multi-layered product on a take-up roller.

A tenth embodiment provides a method as in any of the first through ninth embodiments, further comprising the step of cutting the multi-layered product into sheets.

An eleventh embodiment provides a method as in any of the first through tenth embodiments, wherein the fiber-forming composition comprises a polymer component and at least one solvent.

A twelfth embodiment provides a method as in any of the first through eleventh embodiments, wherein the polymer component is selected from the group consisting of polyurethanes (PU), polycaprolactones (PCL), polyvinyl alcohols (PVA), polymethylmethacrylates (PMMA), poly(vinyldiene fluoride)s (PVDF), polyamides (PA), polyamide-6, polybenzimidazoles (PBI), polycarbonates (PC), polyacrylonitriles (PAN), poly(ethylene-vinyl acetate (EVA), polylactic acids (PLA), polyethylene oxides (PEO), polyethylene terephtalates (PET), polystyrenes (PS), polyvinyphenols (PVP), polyvinylchlorides (PVC), polypropylene, poly(vinylpyrrolidone), cellulose acetates (CA), polyether imides (PEI), polyethylene glycols (PEG), poly(ferrocenyldimethylsilane)s (PFDMS), polyacrylate, polyisobutylene, pressure sensitive adhesives, and mixtures thereof, and the at least one solvent is selected from the group consisting of toluene, tetrahydrofuran (THF), dichloromethane (DCM), chloroform (CHCl₃), methanol, dimethylacetamide (DMAC), dimethyl sulfoxide (DMSO), dimethylformamide (DMF), cyclohexane, butanone, xylene, acetone, ethanol, formic acid, distilled water, trifluoracetic acid, hexafluoro-2-propanol, and mixtures thereof.

A thirteenth embodiment provides a system for producing a dry adhesive product, the system comprising a backing material passing along a first roller to a second roller and having a first surface and a second surface, and a fiber-forming means adapted to apply a fiber-forming composition as a dry adhesive layer on the first surface of the backing material.

A fourteenth embodiment provides a system as in the thirteenth embodiment, wherein the fiber-forming means is an electrospinning apparatus and wherein said dry adhesive layer has a peel strength of 1 psi or less, measured at an angle of separation of 180 degrees, and a shear adhesion of 25 psi or more.

A fifteenth embodiment provides a system as in the either the thirteenth or fourteenth embodiments, further comprising an additional layer adapted to be applied to the second surface of the backing material, where the additional layer is selected from the group consisting of metals, textiles, cellulosic materials, polymer films, plastic films, pressure sensitive adhesives, and foams.

A sixteenth embodiment provides a dry adhesive product comprising an outermost release liner layer positioned on a dry adhesive layer, and a support layer positioned between said dry adhesive layer and a second adhesive layer.

A seventeenth embodiment provides a dry adhesive product as in the sixteenth embodiment, where said second adhesive layer includes an affixing means secured thereto.

An eighteenth embodiment provides a dry adhesive product as in either the sixteenth or seventeenth embodiments, wherein said dry adhesive layer is made from an electrospun polymer and has a peel strength of 1 psi or less, measured at an angle of separation of 180 degrees, and a shear adhesion of 25 psi or more, and where said second adhesive layer is made from an adhesive selected from the group consisting of a pressure sensitive adhesive and a dry adhesive having a peel strength of 1 psi or less, measured at an angle of separation of 180 degrees, and a shear adhesion of 25 psi or more.

A nineteenth embodiment provides a dry adhesive product as in any of the sixteenth through eighteenth embodiments, wherein an affixing means is selected from the group consisting of a hook and a frame hanger.

A twentieth embodiment provides a dry adhesive product as in any of the sixteenth through nineteenth embodiments, wherein said support layer includes two component layers, where a first component layer is made from a foamed material and the second component layer is a substrate selected from metals, textiles, cellulosic materials, polymer films, and plastic films.

### BRIEF DESCRIPTION OF THE DRAWINGS

FIG. 1 is a schematic showing a system according to embodiments of the invention.

FIG. 2 is a schematic showing a dry adhesive product according to embodiments of the invention.

### DETAILED DESCRIPTION OF ILLUSTRATIVE EMBODIMENTS

Embodiments of the present invention are based, at least in part, on methods of manufacturing dry adhesive products. Advantageously, embodiments of the present invention provide continuous methods for manufacturing dry adhesive products. Embodiments of the present invention provide continuous, roll-to-roll methods for manufacturing dry adhesive products. As used herein, the term dry adhesive can be defined as materials having a relatively high shear adhesion and a relatively low peel strength, while also having minimal tack. These materials are also generally capable of attaching, detaching, and reattaching to a broad variety of adherends a number of times. The term dry adhesive will be further described herein below. In one or more embodiments, a dry adhesive layer includes randomly oriented fibers. In these or other embodiments, a dry adhesive layer includes one or more fibers having a planar alignment that is substantially parallel with the planar alignment of an adherend. While the prior art contemplates products made from materials that transversely extend from a backing material, that is, vertically aligned materials, these products made from vertically aligned materials are made using processes that are expensive, intricate, and non-continuous. While the prior art also contemplates products made from fibers that are substantially aligned, the prior art does not contemplate methods for continuously manufacturing these products.

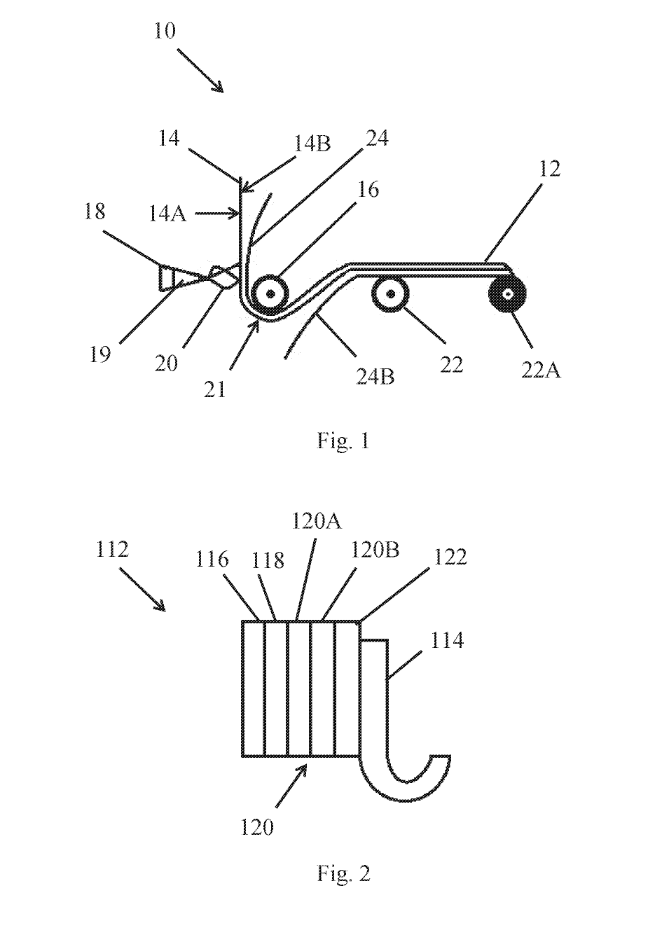

With reference to FIG. 1, embodiments of the invention provide a roll-to-roll system 10 for manufacturing a dry adhesive product 12. A backing means 14, which may also be referred to as a backing material 14, feeds to system 10 and passes along or partially around one or more introduction rollers 16. Feeding backing material 14 to system 10 is generally known to those skilled in the art and may include the use of one or more rollers as described herein below. Introduction roller 16 provides backing material 14 to a fiber-forming means 18, which utilizes a fiber-forming composition 19 to apply one or more polymer fibers 20 onto backing means 14. In one or more embodiments, introduction roller 16 is provided in a position after fiber-forming means 18 applies one or more polymer fibers 20 onto backing means 14, which may also be described as a downstream position. In one or more embodiments, introduction roller 16 is provided in a position before fiber-forming means 18 applies one or more polymer fibers 20 onto backing means 14, which may also be described as an upstream position. In one or more embodiments, a first introduction roller 16 is provided in a position before fiber-forming means 18 applies one or more polymer fibers 20 onto backing means 14 and a second introduction roller 16 is provided in a position after fiber-forming means 18 applies one or more polymer fibers 20 onto backing means 14.

As backing means 14 passes through system 10, fiber-forming means 18 applies one or more polymer fibers 20 to a first side 14A, which may also be described as a first surface 14A, of backing means 14. Polymer fibers 20, which may also be described as spun fiber 20 or electrospun nanofiber 20, form a non-woven fabric 21 on first side 14A of backing means 14, to thereby form dry adhesive product 12. Polymer fibers 20 overlap and collect in a sheet-like form to form non-woven fabric 21, which may also be referred to as dry adhesive 21, dry adhesive layer 21, dry adhesive nanofibers 21, or non-woven dry adhesive 21. In one or more embodiments, polymer fibers 20 do not become embedded or partially embedded in backing means 14. In these or other embodiments, it can be said dry adhesive 21 forms a distinct layer from backing means 14. Polymer fibers 20 can be applied to first side 14A of backing means 14 in the general location of a collection roller. Polymer fiber 20 is made from a suitable fiber-forming composition 19, which will be further described hereinafter.

Polymer fibers 20 collect in an orientation that is substantially coplanar with backing means 14, which may also be described as polymer fibers 20 being substantially parallel with backing means 14. This orientation may also be described as polymer fibers 20 forming a dry adhesive layer including one or more fibers having a planar alignment that is substantially parallel with the planar alignment of backing means 14. This orientation may also be described as polymer fibers 20 being horizontally oriented, where horizontal is with respect to backing means 14, and is distinguished from fibers that are vertically aligned with respect to a backing material. In one or more embodiments, polymer fibers 20 collect in a random orientation. As used herein, random orientation is distinguished from fibers that are substantially aligned with each other. After polymer fiber 20 is applied to backing means 14, backing means 14 can pass along one or more advancing rollers 22.

In one or more embodiments, an additional layer 24 is applied to a second side 14B of backing means 14 before backing means 14 passes to fiber-forming means 18, as shown in FIG. 1. In one or more embodiments, an additional layer 24 is applied to a second side 14B of backing means 14 after backing means 14 passes to fiber-forming means 18. In one or more embodiments, a first additional layer 24 is applied to a second side 14B of backing means 14 before backing means 14 passes to fiber-forming means 18 and a second additional layer 24 is applied to the first additional layer 24 after backing means 14 passes to fiber-forming means 18. In any of the embodiments described herein, any suitable number of additional layers 24 may be utilized. In one or more embodiments, an additional layer is not utilized, such that dry adhesive product 12 includes only backing means 14 and non-woven fabric 21.

In one or more embodiments, an additional layer 24B is applied to non-woven fabric 21. In one or more embodiments, additional layer 24B is a release liner. As will be described further herein, a release liner can include either one releasable side or two releasable sides.

In one or more embodiments, dry adhesive product 12 can proceed to a wraparound roller 22A, which may also be described as a take-up roller 22A, where dry adhesive product 12 can roll onto itself to form a final manufacturing product. In these or other embodiments, dry adhesive product 12 can be cut into sheets. In certain embodiments, dry adhesive product 12 can be cut into sheets without passing to a wraparound roller 22A.

Roll-to-roll system 10 is provided as an exemplary roll-to-roll system. Other suitable roll-to-roll systems may also be utilized for making a dry adhesive product. Suitable roll-to-roll systems may include pull rollers, heating rollers, a heating zone, cooling rollers, a cooling zone, pressure rollers, slitting devices, and take-up rollers. Other suitable roll-to-roll systems may become known to those skilled in the art.

As discussed herein, polymer fiber 20 is applied to a first side 14A of backing means 14 such that backing means 14 serves as a backing material for polymer fiber 20. Backing means 14 may also be described as a support means 14 or collection means 14.

Backing means 14 can be made from any suitable material known to those skilled in the art. For example, backing means 14 can be made from a material selected from the group consisting of metals, textiles, cellulosic materials, polymer films, plastic films, and foams. Suitable metals for backing means 14 include foils, such as aluminum foil. Suitable textiles for backing means 14 include nylon, polyester, polyurethane, acrylic, aramids carbon fiber prepregs, glass fiber prepregs, woven fabrics, sectioned open woven fabrics and other nonwovens. Suitable cellulosic materials for backing means 14 include papers, pulps, cardboards, multilayered compressed pulp, wood, and paper products, cellophane, rayon, organic and inorganic derivatives of cellulose fibers and their layered structures and laminates. Suitable polymer films for backing means 14 include thermoplastics, such as biaxially oriented PET films, biaxially oriented PP film, polyolefins, HDPE, LDPE, and PP plastic resins. Suitable polymer films for backing means 14 include thermosets, such as flexible and elastomer toughened epoxies, elastomer toughened polyimides, low T_{g} compounded thermosets and polyurethanes and other glassy materials. Suitable foams for backing means 14 include open-cell foams, extruded foams, polyurethane foams, polystyrene foams, close-cell foams, syntactic foams, phenolic foams, self-skin foams, sandwich-structured composites, and a variety of deformable foams that enhance conformability of the embodiments on various surfaces, dry and liquid. Methods of making backing means 14 are generally known to those skilled in the art.

In embodiments where backing means 14 is a polymer film, the polymer film backing means 14 can be made by apparatuses selected from the group consisting of sheet extruders, blown film extruders, calenders, and combinations thereof, which are generally known to those skilled in the art.

As discussed herein, in one or more embodiments, additional layer 24B is a release liner that is applied to non-woven fabric 21. Release liners are generally known to those skilled in the art and include paper or plastic based film sheets that are intended to prevent an adhesive surface from prematurely adhering. One or both sides of a release liner can be releasable sides, that is, one or both sides of a release liner can be coated with a release agent. As known in the art, the term release indicates separation of the liner from an adhesive material and the term liner is the carrier for the release agent. Exemplary release agents include silicone and silicone containing materials.

Exemplary release liners include super calendered kraft paper, glassine, clay coated kraft paper, machine finished kraft paper, machine glazed paper, biaxially oriented polyethylene terephthalate film, biaxially oriented polypropylene film, high-density polyethylene plastic resins, low-density polyethylene plastic resins, polypropylene plastic resins, poly coated kraft papers, and poly coated biaxially oriented polyethylene terephthalate film.

As discussed herein, embodiments of system 10 include one or more introduction rollers 16. In these or other embodiments, system 10 includes one or more advancing rollers 22. Introduction rollers 16 and advancing rollers 22 are generally known to those skilled in the art.

Any of the rollers described herein can be characterized by a roller width. In one or more embodiments, a roller has a roller width of 8 inches or more, in other embodiments, 12 inches or more, in other embodiments, 24 inches or more, in other embodiments, 42 inches or more, in other embodiments, 60 inches or more, and in other embodiments, 80 inches or more. In one or more embodiments, a roller has a roller width of 100 inches or less, in other embodiments, 85 inches or less, in other embodiments, 70 inches or less, in other embodiments, 42 inches or less, in other embodiments, 24 inches or less, and in other embodiments, 18 inches or less.

Any of the rollers described herein can be characterized by a rotational speed, where the rotational speed can be adjusted to achieve a desired linear speed of system 10 disclosed elsewhere herein. The diameter of any of the rollers described herein can also be adjusted to achieve a desired linear speed of system 10 disclosed elsewhere herein.

As discussed herein, fiber-forming means 18 uses fiber-forming composition 19 to apply a polymer fiber 20 onto backing means 14. Fiber-forming means 18 can be any suitable apparatus known to those skilled in the art for applying fiber-forming composition 19 as a non-woven fabric. In one or more embodiments, fiber-forming means 18 is a spinning apparatus 18, where a spinning apparatus 18 can be selected from the group consisting of an electrospinning apparatus, a wet spinning apparatus, a dry spinning apparatus, a melt spinning apparatus, and a gel spinning apparatus. In other embodiments, fiber-forming means 18 is a spraying apparatus 18.

Electrospinning apparatuses and processes are generally well known by those skilled in the art. Electrospinning apparatuses and processes create non-woven fabrics made from polymer fibers. In embodiments of the invention, these non-woven fabrics serve as dry adhesive layers. In electrospinning apparatuses and processes, a voltage is applied to a fiber-forming composition held in a spinning tip or spinneret (typically similar to a syringe or needle) directed toward a grounded collector. Electrostatic repulsion counteracts the surface tension of the liquid at the tip and a Taylor cone forms from which a stream of liquid (or jet) erupts toward the collector. The jet elongates and collects on the collector as nanofibers, i.e., fibers with nanometer scale diameters. The collection is typically termed a non-woven fabric, as the nanofibers overlap and collect in a sheet-like form.

Other apparatuses and processes for fiber-forming means 18 are also generally known to those skilled in the art. Wet spinning utilizes a spinneret submerged in a chemical bath, which causes the fiber to precipitate, and then solidify, as the fiber emerges. Dry spinning forms fibers from a spinneret and a stream of air or inert gas is used to evaporate the solvent to thereby solidify the fibers. Melt spinning can be used for polymers that can be melted, where the polymer solidifies by cooling after being extruded from a spinneret. In gel spinning, the polymer is in a ‘gel’ state, that is, only partially liquid, which keeps the polymer chains somewhat bound together. Then, the formed fibers are generally first air dried, then cooled further in a liquid bath. Polymer fibers can also be formed by a spraying process, such as jet spraying or thermal spraying.

Fiber-forming composition 19 may also be referred to as a fiber-forming liquid 19, a spinnable composition 19, a spinnable liquid 19, a jet spray composition 19. In one or more embodiments, fiber-forming composition 19 used to make polymer fiber 20 comprises a polymer component. In one or more embodiments, fiber-forming composition 19 used to make polymer fiber 20 comprises a polymer component and at least one solvent. In one or more embodiments, fiber-forming composition 19 includes a mixture of solvents. The particular polymer component and one or more solvents can be chosen based on the corresponding properties of each. Suitable solvents will be appreciated as being useful for particular polymer components.

The polymer component can be any polymer, or combination of polymers, that will allow fiber-forming composition 19 to form a dry adhesive 21 having suitable strength and adhesion properties. The strength and adhesion properties can be tailored based on a desired application for the dry adhesive product.

The polymer component can be selected from the group consisting of polyurethanes (PU), polycaprolactones (PCL), polyvinyl alcohols (PVA), polymethylmethacrylates (PMMA), poly(vinyldiene fluoride)s (PVDF), polyamides (PA), polyamide-6, polybenzimidazoles (PBI), polycarbonates (PC), polyacrylonitriles (PAN), poly(ethylene-vinyl acetate (EVA), polylactic acids (PLA), polyethylene oxides (PEO), polyethylene terephtalates (PET), polystyrenes (PS), polyvinyphenols (PVP), polyvinylchlorides (PVC), polypropylene, poly(vinylpyrrolidone), cellulose acetates (CA), polyether imides (PEI), polyethylene glycols (PEG), poly(ferrocenyldimethylsilane)s (PFDMS), polyacrylate, polyisobutylene, pressure sensitive adhesives, and mixtures thereof.

Pressure sensitive adhesives are generally based on an elastomer compounded with a suitable tackifier (e.g., a rosin ester). In one or more embodiments, a pressure sensitive adhesive elastomer is chosen from acrylics, butyl rubber, ethylene-vinyl acetate (EVA) with high vinyl acetate content, natural rubber, nitriles, silicone rubbers, styrene block copolymers (SBC), styrene-butadiene-styrene (SBS), styrene-ethylene/butylene-styrene (SEBS), styrene-ethylene/propylene (SEP), styrene-isoprene-styrene (SIS), vinyl ethers, and mixtures thereof.

In one or more embodiments, the polymer component includes at least one polymer having a glass-transition temperature (T_{g}) of 25° C. or lower. In one or more embodiments, the polymer component includes at least two polymers having a glass-transition temperature (T_{g}) of 25° C. or lower. In one or more embodiments, the polymer component includes at least one polymer having a glass-transition temperature (T_{g}) of 25° C. or higher. In one or more embodiments, the polymer component includes at least one polymer having a glass-transition temperature (T_{g}) of 25° C. or lower and at least one polymer having a glass-transition temperature (T_{g}) of 25° C. or higher.

In one or more embodiments, the polymer component includes at least one polymer having a glass-transition temperature (T_{g}) of 50° C. or lower. In one or more embodiments, the polymer component includes at least one polymer having a glass-transition temperature (T_{g}) of 50° C. or higher. In one or more embodiments, the polymer component includes at least one polymer having a glass-transition temperature (T_{g}) of 50° C. or lower and at least one polymer having a glass-transition temperature (T_{g}) of 50° C. or higher.

In one or more embodiments, fiber-forming composition 19 consists essentially of a polymer having a glass-transition temperature (T_{g}) of 25° C. or lower, a polymer having a glass-transition temperature (T_{g}) of 25° C. or higher, and a solvent or solvent mixture. In one or more embodiments, fiber-forming composition 19 consists essentially of a polymer having a glass-transition temperature (T_{g}) of 50° C. or lower, a polymer having a glass-transition temperature (T_{g}) of 50° C. or higher, and a solvent or solvent mixture.

In one or more embodiments, fiber-forming composition 19 consists of a polymer having a glass-transition temperature (T_{g}) of 25° C. or lower, a polymer having a glass-transition temperature (T_{g}) of 25° C. or higher, and a solvent or solvent mixture. In one or more embodiments, fiber-forming composition 19 consists of a polymer having a glass-transition temperature (T_{g}) of 50° C. or lower, a polymer having a glass-transition temperature (T_{g}) of 50° C. or higher, and a solvent or solvent mixture.

The glass-transition temperatures of the polymers provided herein are generally known to those skilled in the art. Generally, polymers having a higher glass-transition temperature will provide strength properties to a resulting non-woven fabric. Generally, polymers having a lower glass-transition temperature will provide conformability properties to a resulting non-woven fabric.

In one or more embodiments, fiber-forming composition 19 includes a polymer component in an amount of 1 wt. % or more, in other embodiments, 3 wt. % or more, in other embodiments, 5 wt. % or more, in other embodiments, 8 wt. % or more, in other embodiments, 10 wt. % or more, in other embodiments, 12 wt. % or more, in other embodiments, 13 wt. % or more, and in other embodiments, 15 wt. % or more. In one or more embodiments, fiber-forming composition 19 includes a polymer component in an amount of 30 wt. % or less, in other embodiments, 25 wt. % or less, in other embodiments, 20 wt. % or less, in other embodiments, 15 wt. % or less, in other embodiments, 10 wt. % or less, and in other embodiments, 8 wt. % or less.

In one or more embodiments, fiber-forming composition 19 includes a polymer component having a first polymer in an amount of from 3 wt. % or more to 18 wt. % or less, with respect to the total fiber-forming composition, and a second polymer in an amount of from 3 wt. % or more to 12 wt. % or less, with respect to the total fiber-forming composition. In one or more embodiments, fiber-forming composition 19 includes a polymer component having a first polymer in an amount of from 5 wt. % or more to 15 wt. % or less, with respect to the total fiber-forming composition, and a second polymer in an amount of from 5 wt. % or more to 10 wt. % or less, with respect to the total fiber-forming composition. In one or more embodiments, fiber-forming composition 19 includes a polymer component having a first polymer in an amount of from 5 wt. % or more to 10 wt. % or less, with respect to the total fiber-forming composition, and a second polymer in an amount of from 5 wt. % or more to 10 wt. % or less, with respect to the total fiber-forming composition.

The viscosity of a fiber-forming composition influences its ability for a fiber-forming means to form polymer fibers therefrom. For example, where fiber-forming means is an electrospinning apparatus, the viscosity of fiber-forming composition must be suitable for electrospinning. Controlling the viscosity of a fiber-forming composition is generally known in the art.

As discussed above, in embodiments where a fiber-forming composition includes one or more solvents, suitable solvents will be appreciated as being useful for particular polymer components. Suitable solvents can be selected from the group consisting of toluene, tetrahydrofuran (THF), dichloromethane (DCM), chloroform (CHCl₃), methanol, dimethylacetamide (DMAC), dimethyl sulfoxide (DMSO), dimethylformamide (DMF), cyclohexane, butanone, xylene, acetone, ethanol, formic acid, distilled water, trifluoracetic acid, hexafluoro-2-propanol, and mixtures thereof.

In one or more embodiments, fiber-forming composition 19 includes a solvent, or mixture of solvents, in an amount from 20 wt. % or more, in other embodiments, 30 wt. % or more, in other embodiments, 50 wt. % or more, in other embodiments, 60 wt. % or more, in other embodiments, 70 wt. % or more, in other embodiments, 80 wt. % or more, and in other embodiments, 85 wt. % or more. In one or more embodiments, fiber-forming composition 19 includes a solvent, or mixture of solvents, in an amount of 90 wt. % or less, in other embodiments, 85 wt. % or less, in other embodiments, 80 wt. % or less, in other embodiments, 70 wt. % or less, in other embodiments, 60 wt. % or less, and in other embodiments, 50 wt. % or less.

In one or more embodiments, fiber-forming composition 19 used to make dry adhesive 21 further comprises one or more additives. As used herein, an additive can be defined as any non-solvent component, or combinations of non-solvent components, included in a fiber-forming composition 19 in addition to the polymer component.

An additive can be selected from the group consisting of tackifiers, surfactants, plasticizers, elastomers, ionomers, block copolymers, flexible plastics, and combinations thereof. Tackifiers are chemical compounds that generally increase the tack of the non-woven, that is, increases the stickiness of the surface. Suitable tackifiers include resins selected from the group consisting of rosins and their derivates, terpenes and modified terpenes, aliphatic, cycloaliphatic and aromatic resins (C5 aliphatic resins, C9 aromatic resins, and C5/C9 aliphatic/aromatic resins), hydrogenated hydrocarbon resins, terpene-phenol resins (TPR, used often with ethylene-vinyl acetate adhesives), and mixtures thereof. Surfactants are compounds that generally lower the surface tension of a composition and suitable surfactants are generally known to those skilled in the art.

In one or more embodiments, an additive is provided in fiber-forming composition 19 to improve the characteristics of fiber-forming means 18. For example, a surfactant may be provided to improve the electrospinning characteristics.

In one or more embodiments, fiber-forming composition 19 includes an additive in an amount from of 1 wt. % or more, in other embodiments, 3 wt. % or more, in other embodiments, 5 wt. % or more, in other embodiments, 8 wt. % or more, in other embodiments, 10 wt. % or more, in other embodiments, 12 wt. % or more, in other embodiments, 13 wt. % or more, and in other embodiments, 15 wt. % or more. In one or more embodiments, fiber-forming composition 19 includes an additive in an amount of 20 wt. % or less, in other embodiments, 15 wt. % or less, in other embodiments, 12 wt. % or less, in other embodiments, 10 wt. % or less, in other embodiments, 8 wt. % or less, and in other embodiments, 5 wt. % or less

As discussed herein, one or more embodiments of the invention utilize one or more additional layers 24. Additional layer 24 can be made from any suitable material known to those skilled in the art. Additional layer 24 can be made from any of the materials disclosed above with respect to backing means 14. For example, additional layer 24 can be made from a material selected from the group consisting of metals, textiles, cellulosic materials, polymer films, plastic films, pressure sensitive adhesives, and foams. Suitable metals for additional layer 24 include foils, such as aluminum foil. Suitable textiles for additional layer 24 include nylon, polyester, polyurethane, acrylic, aramids carbon fiber prepregs, glass fiber prepregs, woven fabrics, sectioned open woven fabrics, and other nonwovens. Suitable cellulosic materials for additional layer 24 include papers, pulps, cardboards, multilayed compressed pulp, wood and paper products, cellophane, rayon, organic and inorganic derivatives of cellulose fibers and their layered structures and laminates. Suitable polymer films for additional layer 24 include thermoplastics, such as biaxially oriented PET films, biaxially oriented PP film, polyolefins, HDPE, LDPE, and PP plastic resins. Suitable polymer films for additional layer 24 include thermosets, such as such as flexible and elastomer toughened epoxies, elastomer toughened polyimides, low Tg compounded thermosets and polyurethanes and other glassy materials. Suitable foams for additional layer 24 include open-cell foams, extruded foams, polyurethane foams, polystyrene foams, close-cell foams, syntactic foams, phenolic foams, self-skin foams, sandwich-structured composites, and a variety of deformable foams that enhance conformability of the embodiments on various surfaces, dry and liquid.

In one or more embodiments, additional layer 24 can be made from the same material as backing means 14. In one or more embodiments, additional layer 24 can be made from different material than backing means 14.

A dry adhesive product can be characterized by the properties of a dry adhesive layer, which may also be referred to as a dry adhesive or a non-woven dry adhesive, utilized therein. As discussed above, a dry adhesive layer may also be referred to as a non-woven fabric.

As described above, in one or more embodiments, the term dry adhesive can be defined as materials having a relatively high shear adhesion and a relatively low peel strength, while being capable of attaching, detaching, and reattaching to a broad variety of adherends a number of times. In particular embodiments, the term dry adhesive can be defined as a material having a shear adhesion greater than 100 psi and a peel strength of 0.10 psi or less, measured at 180 degrees. In particular embodiments, the term dry adhesive can be defined as an interlayered material having a shear adhesion greater than 25 psi and a peel strength of 1 psi or less, measured at 180 degrees. In one or more embodiments, a dry adhesive product can be an interlayered material. In one or more embodiments, the term dry adhesive relates to materials having minimal tack. In certain embodiments, a dry adhesive layer can be fine tuned to have peel force exceeding 0 psi while remaining free of tack.

In one or more embodiments, a dry adhesive layer allows for a dry adhesive product to be repositionable. This can also be described as the dry adhesive product being reusable. By repositionable and reusable, it is meant that dry adhesive product can be first adhered to an adherend, then removed from the adherend, and then re-adhered to an adherend. In one or more embodiments, the removal and re-adhering occurs without damaging the adherend, for example, not tearing the adherend, and occurs without leaving a residue on the adherend. This can be distinguished from adhesives that irreversibly affix into position. For example, UV-cured or heat-cured adhesives generally cannot be removed from an adherend once the adhesive has been cured. Also, pressure sensitive adhesives often damage the adherend upon removing the pressure sensitive adhesive from the adherend.

In one or more embodiments, the fiber diameter of a dry adhesive layer is less than or equal to 10 microns. In other embodiments, the fiber diameter of a dry adhesive layer is less than or equal to 1 microns, in other embodiments, less than or equal to 500 nanometers, in other embodiments, less than or equal to 100 nanometers, and in other embodiments, less than or equal to 50 nanometers. In one or more embodiments, the fiber diameter of a dry adhesive layer is from 50 nanometers or more to 500 nanometers or less.

In one or more embodiments, a dry adhesive layer can be characterized by grams per square meter (GSM), which is measurement known in the art relating to weight and thickness. In one or more embodiments, a dry adhesive layer is 0.1 GSM or more, in other embodiments, 0.5 GSM or more, in other embodiments, 1 GSM or more, in other embodiments, 3 GSM or more, in other embodiments, 5 GSM or more, in other embodiments, 10 GSM or more, in other embodiments, 15 GSM or more, in other embodiments, 20 GSM or more, and in other embodiments, 25 GSM or more. In one or more embodiments, a dry adhesive layer is 50 GSM or less, in other embodiments, 40 GSM or less, in other embodiments, 30 GSM or less, in other embodiments, 25 GSM or less, in other embodiments, 20 GSM or less, in other embodiments, 10 GSM or less, in other embodiments, 5 GSM or less, in other embodiments, 2 GSM or less, in other embodiments, 1 GSM or less, in other embodiments, 0.8 GSM or less, and in other embodiments, 0.3 GSM or less.

In one or more embodiments, the porosity of a dry adhesive layer is 70% or more. In other embodiments, the porosity of a dry adhesive layer is 75% or more, in other embodiments, 80% or more, in other embodiments, 85% or more, and in other embodiments, 90% or more. In one or more embodiments, the porosity of a dry adhesive layer is 95% or less, in other embodiments, 90% or less, in other embodiments, 85% or less, and in other embodiments, 80% or less.

Embodiments of the invention provide dry adhesive products including dry adhesive layers having relatively higher shear adhesion while also having relatively lower normal lifting force. Shear adhesion is the adhesion strength measured in a direction that is generally parallel to the surface of the material. Said another way, shear adhesion strength is a measure of the ability of a dry adhesive layer to remain adhered with a load applied parallel to the surface of the dry adhesive layer. Normal lifting force is the adhesion strength measured in a direction that is generally perpendicular with the surface of the material. A large difference between shear adhesion and normal adhesion, that is, a high shear adhesion and a low normal adhesion, is desired in order to easily switch between attachment and detachment. In one or more embodiments, a dry adhesive layer has a shear adhesion strength that is higher than the normal adhesion strength. Suitable testing methods, such as ASTM D3654/D3654M-06(2011), are generally known to those skilled in the art.

In one or more embodiments, a dry adhesive layer has a shear adhesion of 25 psi or more, in other embodiments, 45 psi or more, in other embodiments, 60 psi or more, in other embodiments, 75 psi or more, in other embodiments, 80 psi or more, in other embodiments, 90 psi or more, in other embodiments, 110 psi or more, in other embodiments, 140 psi or more, and in other embodiments, 150 psi or more. In one or more embodiments, a dry adhesive layer has a shear adhesion of 200 psi or more, in other embodiments, 400 psi or more, in other embodiments, 600 psi or more, in other embodiments, 800 psi or more, and in other embodiments, 1000 psi or more. In one or more embodiments, where a dry adhesive layer is on a backing material, the dry adhesive layer may have a shear adhesion that is higher than the tensile strength of the backing material. In one or more embodiments, a dry adhesive layer has a shear adhesion of 200 psi or less, in other embodiments, 150 psi or less, in other embodiments, 100 psi or less, in other embodiments, 75 psi or less, and in other embodiments, 50 psi or less. In one or more embodiments, a dry adhesive layer has a shear adhesion of from 40 psi to 150 psi, in other embodiments, from 100 psi to 150 psi, in other embodiments, from 60 psi to 100 psi, in other embodiments, from 60 psi to 140 psi, and in other embodiments, from 70 psi to 110 psi. In one or more embodiments, a dry adhesive layer has a shear adhesion of from 100 psi to 1000 psi, in other embodiments, from 100 psi to 2000 psi, and in other embodiments, from 200 psi to 1000 psi.

In one or more embodiments, a dry adhesive layer has a shear adhesion of from 40 psi to 60 psi on a painted drywall. In one or more embodiments, a dry adhesive layer has a shear adhesion of 50 psi, or approximate thereto, on a painted drywall. In one or more embodiments, a dry adhesive layer is removable from a painted drywall after four months of adhesion to the painted drywall. In these or other embodiments, a dry adhesive layer leaves no residue on a painted drywall. In one or more embodiments, a dry adhesive layer has a shear adhesion of from 140 psi to 160 psi on a steel plate. In one or more embodiments, a dry adhesive layer has a shear adhesion of 150 psi, or approximate thereto, on a steel plate.

In one or more embodiments, a dry adhesive layer has a normal adhesion of 20 pounds per square inch (psi) or less, in other embodiments, 10 psi or less, in other embodiments, 5 psi or less, in other embodiments, 1 psi or less in other embodiments, 0.5 psi or less in other embodiments, 0.1 psi or less, and in other embodiments, 0.01 psi or less. In one or more embodiments, a dry adhesive layer has a normal adhesion of 0 psi, or approximate thereto. In one or more embodiments, a dry adhesive layer has a normal adhesion of from 0.01 psi to 0.5 psi, in other embodiments, from 0.001 psi to 0.1 psi, and in other embodiments, from 0.01 psi to 0.1 psi.

In one or more embodiments, a dry adhesive layer can be characterized by a ratio of shear adhesion to normal adhesion. Any of the above provided shear adhesion values can be divided by any of the above provided normal adhesion values to determine a ratio of shear adhesion to normal adhesion. Where the normal adhesion is 0 psi, or approximate thereto, it might be said that the ratio of shear adhesion to normal adhesion approaches infinity, based on the inability to divide by zero.

The tackiness or tack of an adhesive, which may also be referred to as the initial adhesion, is the adhesion strength under slight pressure or preload. In one or more embodiments, a dry adhesive layer has minimal tack, where minimal tack can be characterized using ASTM standards ASTM D2979-01(2009), ASTM D6195, ASTM D3121, and ASTM C679-15.

Embodiments of the invention provide dry adhesive products including dry adhesive layers having relatively higher shear adhesion while also having relatively lower peel strength. Peel strength is generally known to those skilled in the art and is generally a measurement of the force required to separate a bonded, or adhered, material. Peel strength can also be described as measuring the bond strength of an adhesive, in a generally normal direction. Embodiments of the invention provide a dry adhesive layer having relatively low peel strength, so that the dry adhesive product can be removed and reused. Tests for peel strength are generally known to those skilled in the art and include ASTM D903.

In one or more embodiments, a dry adhesive layer has a peel strength of 1 pound per square inch (psi) or less, in other embodiments, 0.5 psi or less, in other embodiments, 0.15 psi or less, in other embodiments, 0.10 psi or less, in other embodiments, 0.05 psi or less, and in other embodiments, 0.01 psi or less. In one or more embodiments, a dry adhesive layer has a negligibly small (that is, close to 0) peel strength. In one or more embodiments, a dry adhesive layer has a peel strength of from 0.01 psi to 0.10 psi, in other embodiments, from 0.01 psi to 0.05 psi, in other embodiments, from 0.10 psi to 1 psi, and in other embodiments, from 0.05 psi to 0.10 psi.

In one or more embodiments, peel strength is measured using a test with an angle of separation, which may also be referred to as the peel angle, of 90 degrees. In one or more embodiments, peel strength is measured using a test with an angle of separation of 180 degrees.

Roll-to-roll system 10 and any other suitable roll-to-roll system can be characterized by the process conditions thereof. In one or more embodiments, a roll-to-roll system operates at a temperature of −10° C. or higher, in other embodiments, 0° C. or higher, in other embodiments, 10° C. or higher, in other embodiments, 25° C. or higher, in other embodiments, 30° C. or higher, in other embodiments, 40° C. or higher, in other embodiments, 50° C. or higher, and in other embodiments, 55° C. or higher. In one or more embodiments, a roll-to-roll system operates at a temperature of 100° C. or lower, in other embodiments, 85° C. or lower, in other embodiments, 70° C. or lower, in other embodiments, 55° C. or lower, in other embodiments, 40° C. or lower, and in other embodiments, 30° C. or lower.

In one or more embodiments, a roll-to-roll system travels at a linear speed of 1 feet per minute (fpm) or more, in other embodiments, 2 fpm or more, in other embodiments, 3 fpm or more, in other embodiments, 5 fpm or more, in other embodiments, 10 fpm or more, in other embodiments, 15 fpm or more, in other embodiments, 25 fpm or more, in other embodiments, 35 fpm or more, and in other embodiments, 50 fpm or more. In one or more embodiments, a roll-to-roll system travels at a linear speed of 100 feet per minute (fpm) or more, in other embodiments, 150 fpm or more, in other embodiments, 250 fpm or more, in other embodiments, 300 fpm or more, in other embodiments, 400 fpm or more, in other embodiments, 500 fpm or more, in other embodiments, 650 fpm or more, in other embodiments, 750 fpm or more, and in other embodiments, 900 fpm or more.

In one or more embodiments, a roll-to-roll system travels at a linear speed of 1 feet per minute (fpm) or less, in other embodiments, 2 fpm or less, in other embodiments, 3 fpm or less, in other embodiments, 5 fpm or less, in other embodiments, 10 fpm or less, in other embodiments, 15 fpm or less, in other embodiments, 25 fpm or less, in other embodiments, 35 fpm or less, and in other embodiments, 50 fpm or less. In one or more embodiments, a roll-to-roll system travels at a linear speed of 100 feet per minute (fpm) or less, in other embodiments, 200 fpm or less, in other embodiments, 350 fpm or less, in other embodiments, 500 fpm or less, in other embodiments, 750 fpm or less, in other embodiments, 900 fpm or less, in other embodiments, 1000 fpm or less, in other embodiments, 1100 fpm or less, and in other embodiments, 1200 fpm or less.

The above described linear speeds can relate to the speed of backing material 14. The above described linear speeds can also relate to the speed of any of the additional layers 24, 24B, where present. The above described linear speeds can also relate to the speed of dry adhesive product 12.

Embodiments of the invention provide a method of manufacturing a dry adhesive product. In one or more embodiments, a method of manufacturing a dry adhesive product includes steps of providing a fiber-forming composition to a fiber-forming means; providing a backing material; advancing the backing material to the fiber-forming means; and allowing the fiber-forming means to form a dry adhesive layer made from the fiber-forming composition on a first surface of the backing material.

In one or more embodiments, a method of manufacturing a dry adhesive product includes steps of providing a fiber-forming composition to a fiber-forming means; passing a backing material having a first surface and a second surface along a first roller to thereby advance the backing material to the fiber-forming means; allowing the fiber-forming means to form a dry adhesive layer made from the fiber-forming composition on the first surface of the backing material; and passing the backing material having the dry adhesive layer thereon along a second roller.

In one or more embodiments, all steps are performed continuously. In one or more embodiments, the steps of passing a backing material along a first roller, allowing the fiber-forming means to form a dry adhesive layer, and passing the backing material having the dry adhesive layer thereon along a second roller are performed continuously.

In one or more embodiments, a method of manufacturing a dry adhesive product includes steps of utilizing an introduction roller to provide a backing means in proximity to a fiber-forming means; applying polymer fibers to a first side of the backing means to thereby form a dry adhesive layer on the first side; and applying a release liner to the dry adhesive layer. In these or other embodiments a method of manufacturing a dry adhesive product includes applying an additional layer to a second side of backing means. In these or other embodiments, a method of manufacturing a dry adhesive product includes collecting a dry adhesive product on a take-up roller. In these or other embodiments, a method of manufacturing a dry adhesive product includes cutting a dry adhesive product into sheets.

In one or more embodiments, a method of manufacturing a dry adhesive product can be generally described as a lamination method. As known to those skilled in the art, lamination is a technique of manufacturing a material in multiple layers. In one or more embodiments, a method of manufacturing a dry adhesive includes laminating a dry adhesive on a textile composition. In one or more embodiments, a method of manufacturing a dry adhesive product includes laminating a dry adhesive layer with a thermoplastic.

In one or more embodiments, a method of manufacturing a dry adhesive product includes a finishing step, wherein a finishing step further prepares a dry adhesive product. In one or more embodiments, a finishing step include punching one or more holes in a dry adhesive product.

A dry adhesive product can take many suitable forms. In one or more embodiments, a dry adhesive product can be selected from the group consisting of a textile, a rolled product, a sheet, and a printable sheet. In these or other embodiments, a dry adhesive product can be selected from the group consisting of tape, a label, an adhesive tab, a sealant, a film, a cling, a poster, wallpaper, a dry-erase board, a magnet, and a laminate. In one or more embodiments, a dry adhesive product includes a plurality of layers, as elsewhere described herein.

With reference to FIG. 2, embodiments of the invention provide a dry adhesive product 112 with an optional affixing means 114. A release liner layer 116 is provided on one side of a dry adhesive layer 118 and forms an outermost layer of dry adhesive product 112. In this way, release liner layer 116 can be removed in order to secure dry adhesive layer 118 to an adherend, such as a wall. As described above, dry adhesive layer 118 is advantageously repositionable, meaning that dry adhesive product 112 can be first adhered to an adherend, then removed from the adherend, and then re-adhered to an adherend.

In one or more embodiments, the surface of dry adhesive product 112 opposite release liner includes an affixing means 114. Affixing means 114 are generally known to those skilled in the art and are generally those structures that will receive and positionably secure another object, such as a picture frame. Exemplary affixing means 114 include hooks and frame hangers. In one or more embodiments, dry adhesive product 112 does not include an affixing means 114.

The disclosure herein with respect to embodiments where additional layer 24B is a release liner also applies to release liner layer 116. The disclosure herein with respect to fiber-forming composition 19 and dry adhesive 21 also applies to dry adhesive layer 118.

In one or more embodiments, the side of dry adhesive layer 118 opposite release liner layer 116 includes one or more support layers 120 for providing suitable support to dry adhesive product 112. As shown in FIG. 2, one or more embodiments of the invention provide two support layers, including a substrate layer 120A and a foam layer 120B. In one or more embodiments, one or more support layers 120 includes only one or more substrate layers 120A. In one or more embodiments, one or more support layers 120 includes only one or more foam layers 120B.

The disclosure herein with respect to additional layer 24 also applies to substrate layer 120A.

Foams suitable for foam layer 120B are generally known to those skilled in the art. Exemplary foams for foam layer 120B include open-cell foams, extruded foams, polyurethane foams, polystyrene foams, close-cell foams, syntactic foams, phenolic foams, self-skin foams, sandwich-structured composites, and a variety of deformable foams.

In one or more embodiments, the side of one or more support layers 120 opposite dry adhesive layer 118 includes a second adhesive layer 122. Second adhesive layer 122 can be made from any suitable adhesive, including a dry adhesive layer as described herein. In one or more embodiments, second adhesive layer 122 is made from a permanent adhesive, where a permanent adhesive is an adhesive that is not a reusable adhesive. In one or more embodiments, second adhesive layer 122 is made from a pressure sensitive adhesive. In one or more embodiments, second adhesive layer 122 includes a release liner layer positioned thereon.

In embodiments where affixing means 114 is present, adhesive layer 122 secures affixing means 114 thereto. In embodiments where affixing means 114 is not present, second adhesive layer 122 can affix to an object, and dry adhesive layer 118 can be affixed to an adherend. For example, adhesive layer 122 can be affixed to a picture frame and dry adhesive layer 118 can be affixed to a wall.

Advantageously, embodiments of the invention provide methods of manufacturing a dry adhesive product providing one or more manufacturing improvements. Embodiments of the invention provide methods that provide one or more of: reduced operating costs; lower initial capital costs; and improved commercial scalability.

In light of the foregoing, it should be appreciated that the present invention significantly advances the art. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A method for producing a dry adhesive product comprising the steps of:
providing a fiber-forming composition to a fiber-forming means;
passing a backing material having a first surface and a second surface along a first roller to thereby advance the backing material to the fiber-forming means;
allowing the fiber-forming means to form a dry adhesive layer made from the fiber-forming composition on the first surface of the backing material; and
passing the backing material having the dry adhesive layer thereon along a second roller.

2. The method of claim 1, wherein the fiber-forming means is an electrospinning apparatus, such that said step of allowing is a step of electrospinning.

3. The method of claim 1, wherein said steps of passing a backing material along a first roller, allowing the fiber-forming means to form a dry adhesive layer, and passing the backing material having the dry adhesive layer thereon along a second roller are performed continuously.

4. The method of claim 1, wherein all steps are performed continuously.

5. The method of claim 1, further comprising a step of applying an additional layer to the second surface of the backing material before the backing material is advanced to the fiber-forming means and wherein the first roller is positioned downstream from the fiber-forming means.

6. The method of claim 5, where the backing material is selected from the group consisting of metals, textiles, cellulosic materials, polymer films, plastic films, and foams, and where the additional layer is selected from the group consisting of metals, textiles, cellulosic materials, polymer films, plastic films, pressure sensitive adhesives, and foams.

7. The method of claim 1, wherein the dry adhesive layer has a peel strength of 1 psi or less, measured at an angle of separation of 180 degrees, and a shear adhesion of 25 psi or more.

8. The method of claim 1, further comprising the step of applying a release liner to the dry adhesive layer to form a multi-layered product.

9. The method of claim 8, further comprising the step of collecting the multi-layered product on a take-up roller.

10. The method of claim 8, further comprising the step of cutting the multi-layered product into sheets.

11. The method of claim 1, wherein the fiber-forming composition comprises a polymer component and at least one solvent.

12. The method of claim 11, wherein the polymer component is selected from the group consisting of polyurethanes (PU), polycaprolactones (PCL), polyvinyl alcohols (PVA), polymethylmethacrylates (PMMA), poly(vinyldiene fluoride)s (PVDF), polyamides (PA), polyamide-6, polybenzimidazoles (PBI), polycarbonates (PC), polyacrylonitriles (PAN), poly(ethylene-vinyl acetate (EVA), polylactic acids (PLA), polyethylene oxides (PEO), polyethylene terephtalates (PET), polystyrenes (PS), polyvinyphenols (PVP), polyvinylchlorides (PVC), polypropylene, poly(vinylpyrrolidone), cellulose acetates (CA), polyether imides (PEI), polyethylene glycols (PEG), poly(ferrocenyldimethylsilane)s (PFDMS), polyacrylate, polyisobutylene, pressure sensitive adhesives, and mixtures thereof, and the at least one solvent is selected from the group consisting of toluene, tetrahydrofuran (THF), dichloromethane (DCM), chloroform (CHCl₃), methanol, dimethylacetamide (DMAC), dimethyl sulfoxide (DMSO), dimethylformamide (DMF), cyclohexane, butanone, xylene, acetone, ethanol, formic acid, distilled water, trifluoracetic acid, hexafluoro-2-propanol, and mixtures thereof.

13. A system for producing a dry adhesive product, the system comprising a backing material passing along a first roller to a second roller and having a first surface and a second surface, and a fiber-forming means adapted to apply a fiber-forming composition as a dry adhesive layer on the first surface of the backing material.

14. The system of claim 13, wherein the fiber-forming means is an electrospinning apparatus and wherein said dry adhesive layer has a peel strength of 1 psi or less, measured at an angle of separation of 180 degrees, and a shear adhesion of 25 psi or more.

15. The system of claim 13, further comprising an additional layer adapted to be applied to the second surface of the backing material, where the additional layer is selected from the group consisting of metals, textiles, cellulosic materials, polymer films, plastic films, pressure sensitive adhesives, and foams.

16. A dry adhesive product comprising an outermost release liner layer positioned on a dry adhesive layer, and a support layer positioned between said dry adhesive layer and a second adhesive layer.

17. The dry adhesive product of claim 16, where said second adhesive layer includes an affixing means secured thereto.

18. The dry adhesive product of claim 16, wherein said dry adhesive layer is made from an electrospun polymer and has a peel strength of 1 psi or less, measured at an angle of separation of 180 degrees, and a shear adhesion of 25 psi or more, and where said second adhesive layer is made from an adhesive selected from the group consisting of a pressure sensitive adhesive and a dry adhesive having a peel strength of 1 psi or less, measured at an angle of separation of 180 degrees, and a shear adhesion of 25 psi or more.

19. The dry adhesive product of claim 17, wherein said affixing means is selected from the group consisting of a hook and a frame hanger.

20. The dry adhesive product of claim 16, wherein said support layer includes two component layers, where a first component layer is made from a foamed material and the second component layer is a substrate selected from metals, textiles, cellulosic materials, polymer films, and plastic films.
